(19) United States
(12) Patent Application Publication
(10) Pub. No.: US 2023/0063752 A1
(43) Pub. Date: Mar. 2, 2023

(54) Method for Human Characteristic and Object Characteristic Identification for Retail Loss Prevention at the Point of Sale

(71) Applicant: ZEBRA TECHNOLOGIES CORPORATION, Lincolnshire, IL (US)

(72) Inventors: Matthew V. Avallone, Dix Hills, NY (US); Christopher J. Fjellstad, Smithtown, NY (US)

(21) Appl. No.: 17/462,886

(22) Filed: Aug. 31, 2021

(51) Int. Cl. G06K 9/00; G06K 9/46; G06K 9/20; G06Q 20/20; G06K 7/14

(52) U.S. Cl. CPC G06K 9/00624; G06K 9/00268; G06K 9/00362; G06K 9/4652; G06K 9/2027; G06Q 20/208; G06K 7/1413; G06K 7/1447; G06F 16/22

(57) ABSTRACT

Methods for human characteristic and object characteristic identification at a point of sale (POS)) are disclosed herein. An example method includes capturing, a series of image frames of a product scanning region for each item passing through the product scanning region at the POS workstation. A first set of image frames of the series of image frames for each item may be captured using a first illumination setting configured for a first background brightness level, and a second set of image frames of the series of image frames for each item may be captured using a second illumination setting that is configured for a second background brightness level. The first set of image frames may be analyzed to identify an individual associated with the item, and the second set of image frames may be analyzed to identify the item.

### BACKGROUND

Retail loss at the point of sale (POS), also called “shrinkage,” which includes any business cost caused by deliberate or inadvertent human actions, is at all-time high, accounting for 1.62% of a typical retailer's bottom line according to the 2020 NRF National Retail Security Survey. This cost the retail industry as a whole $61.7 billion, with seven in ten surveyed retailers reporting a shrink rate exceeding 1%. While shrinkage impacts every aspect of a retailer's operations, the top source of shrinkage was reported as external theft (i.e., shoplifting). External theft can occur in multiple ways. The most common form of external theft is directly stealing items at the POS.

### SUMMARY

In an embodiment, the present invention is a method for human characteristic and object characteristic identification at a point of sale (POS), comprising: capturing, by an imaging assembly associated with a barcode reader configured for use at a POS workstation, a series of image frames of a product scanning region associated with the POS workstation for each item passing through the product scanning region, wherein a first set of one or more image frames of the series of image frames for each item is captured using a first illumination setting configured for a first background brightness level in the image frames, wherein a second set of one or more image frames of the series of image frames for each item is captured using a second illumination setting, wherein the second illumination setting is configured for a second background brightness level, different from the first background brightness level, in the image frames; analyzing the first set of one or more image frames to identify one or more characteristics of an individual associated with the item passing through the product scanning region; and analyzing the second set of one or more image frames to identify the item passing through the product scanning region.

In a variation of this embodiment, the first background brightness level is brighter than the second background brightness level.

Additionally, in a variation of this embodiment, analyzing the second set of one or more image frames to identify the item includes using object recognition techniques to identify the item passing through the product scanning region based on the second set of one or more image frames.

Furthermore, in a variation of this embodiment, analyzing the first set of one or more image frames to identify one or more characteristics associated with the individual associated with the item passing through the product scanning region includes identifying, based on the first set of one or more image frames, one or more of: one or more articles of clothing being worn by the individual, one or more colors of articles of clothing being worn by the individual, an approximate height of the individual, an approximate weight of the individual, or one or more facial features of the individual.

Additionally, in a variation of this embodiment, the method includes storing the first set of one or more image frames in a security database.

Moreover, in a variation of this embodiment, the method further includes comparing the first set of one or more image frames to a third set of one or more image frames from security video footage for a store location with which the POS workstation is associated; and identifying, based on the comparison, an individual associated with the item passing through the product scanning region shown in the third set of one or more image frames.

In another embodiment, the present invention is a system for human characteristic and object characteristic identification at a point of sale (POS), comprising: an imaging assembly, associated with a barcode reader configured for use at a POS workstation, configured to capture a series of image frames of a product scanning region associated with the POS workstation for each item passing through the product scanning region; an illumination assembly, associated with the barcode reader configured for use at the POS workstation, configured to: for a first set of one or more image frames of the series of image frames, illuminate the product scanning region using a first illumination setting configured for a first background brightness level in the image frames; for a second set of one or more image frames of the series of image frames, illuminate the product scanning region using a second illumination setting configured for a second background brightness level in the image frames, wherein the second background brightness level is different from the first background brightness level; one or more processors, and a memory storing non-transitory computer-readable instructions that, when executed by the one or more processors, cause the one or more processors to analyze the first set of one or more image frames to identify one or more characteristics of an individual associated with the item passing through the product scanning region and analyze the second set of one or more image frames to identify the item passing through the product scanning region.

In a variation of this embodiment, the first background brightness level is brighter than the second background brightness level.

Moreover, in a variation of this embodiment, the instructions, when executed by the one or more processors, cause the one or more processors to analyze the second set of one or more image frames to identify the item by using object recognition techniques to identify the item passing through the product scanning region based on the second set of one or more image frames.

Additionally, in a variation of this embodiment, the instructions, when executed by the one or more processors, cause the one or more processors to analyze the first set of one or more image frames to identify one or more characteristics associated with the individual by identifying, based on the first set of one or more image frames, one or more of: one or more articles of clothing being worn by the individual, one or more colors of articles of clothing being worn by the individual, an approximate height of the individual, an approximate weight of the individual, or one or more facial features of the individual.

Moreover, in a variation of this embodiment, the instructions, when executed by the one or more processors, further cause the one or more processors to store the first set of one or more image frames in a security database.

Furthermore, in a variation of this embodiment, the instructions, when executed by the one or more processors, further cause the one or more processors to: compare the first set of one or more image frames to a third set of one or more image frames from security video footage for a store location with which the POS workstation is associated; and identify, based on the comparison, an individual associated with the item passing through the product scanning region shown in the third set of one or more image frames.

In yet another embodiment, the present invention is a barcode reader device configured for use at a point of sale (POS) workstation, for human characteristic and object characteristic identification, comprising: an imaging assembly configured to capture a series of image frames of a product scanning region associated with the POS workstation for each item passing through the product scanning region; an illumination assembly configured to: for a first set of one or more image frames of the series of image frames, illuminate the product scanning region using a first illumination setting configured for a first background brightness level in the image frames; for a second set of one or more image frames of the series of image frames, illuminate the product scanning region using a second illumination setting configured for a second background brightness level in the image frames, wherein the second background brightness level is different from the first background brightness level; and a controller configured to communicate with a memory storing non-transitory computer-readable instructions that, when executed by one or more processors, cause the one or more processors to analyze the first set of one or more image frames to identify one or more characteristics of an individual associated with the item passing through the product scanning region and analyze the second set of one or more image frames to identify the item passing through the product scanning region.

In a variation of this embodiment, the memory is located in one or more of the barcode reader device or a remote server.

Additionally, in a variation of this embodiment, the first background brightness level is brighter than the second background brightness level.

Moreover, in a variation of this embodiment, the instructions, when executed by the one or more processors, cause the one or more processors to analyze the second set of one or more image frames to identify the item by using object recognition techniques to identify the item passing through the product scanning region based on the second set of one or more image frames.

Additionally, in a variation of this embodiment, the instructions, when executed by the one or more processors, cause the one or more processors to analyze the first set of one or more image frames to identify one or more characteristics associated with the individual by identifying, based on the first set of one or more image frames, one or more of: one or more articles of clothing being worn by the individual, one or more colors of articles of clothing being worn by the individual, an approximate height of the individual, an approximate weight of the individual, or one or more facial features of the individual.

Moreover, in a variation of this embodiment, the instructions, when executed by the one or more processors, further cause the one or more processors to store the first set of one or more image frames in a security database.

Furthermore, in a variation of this embodiment, the instructions, when executed by the one or more processors, further cause the one or more processors to: compare the first set of one or more image frames to a third set of one or more image frames from security video footage for a store location with which the POS workstation is associated; and identify, based on the comparison, an individual associated with the item passing through the product scanning region shown in the third set of one or more image frames.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of an example point of sale (POS) system as may be used to implement example methods and/or operations described herein, including methods and/or operations for identifying a person at a POS.

FIG. 2 illustrates a block diagram of an example system including a logic circuit for implementing example methods and/or operations described herein, including methods and/or operations for identifying a person at a POS.

FIG. 3 illustrates an example series of image frames of a product scanning region, as may be captured using the system of FIG. 2, with one image frame of the series of image frames captured using illumination settings configured for a brighter background and other image frames of the series of image frames captured using illumination setting configured for a darker background, in accordance with some embodiments.

FIG. 4 illustrates an example image frame of a product scanning region, as may be captured using the system of FIG. 2, captured using illumination settings configured for a brighter background so that an individual depicted in the image frame may be identified, in accordance with some embodiments.

FIG. 5 illustrates a block diagram of an example process as may be implemented by the system of FIG. 2, for implementing example methods and/or operations described herein, including methods and/or operations for identifying a person at a POS.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure provides techniques for identifying a person at a point of sale (POS). Existing retail loss prevention systems use illumination to darken the background of every image, so that the foreground of the image stands out, i.e., to make it easier to perform image processing on an item of interest in a product scanning region depicted in the foreground of the image. However, when the background of the image is darkened, it can be difficult to use the same image to identify a human operator, who will typically be depicted in the background of the image. Accordingly, the present disclosure provides techniques for capturing a sequence of images from a color camera associated with a bioptic camera, including a video sequence with a darkened background, and a snapshot image at the beginning of the sequence with an illuminated background. Thus, the video sequence with the darkened background may be analyzed to identify an item of interest in the foreground of the image, and the snapshot image at the beginning of the sequence with the illuminated background may be analyzed to identify features associated with the human operator in the background of the image. In some examples, these identified features may be used to identify the human operator. Moreover, in some examples, the image with the illuminated background may be stored in a database and used for monitoring the human operator, in images captured by security cameras associated with the retail store, as he or she moves throughout the retail store, i.e., to detect future theft events.

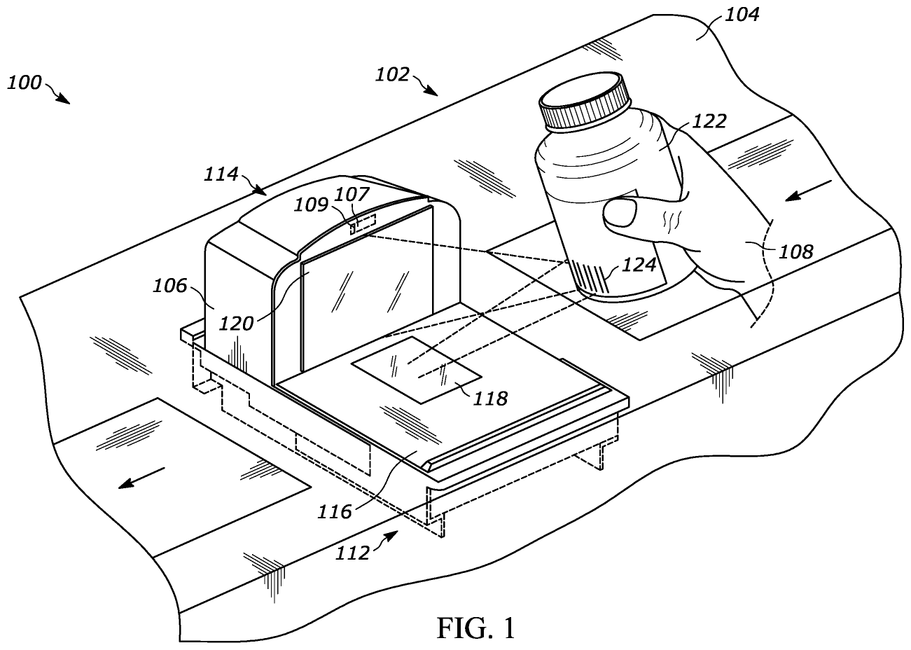

FIG. 1 illustrates a perspective view of an example imaging system capable of implementing operations of the example methods described herein, as may be represented by the flowcharts of the drawings that accompany this description. In the illustrated example, an imaging system 100 is in the form of a point-of-sale (POS) system, having a workstation 102 with a counter 104, a bi-optical (also referred to as “bi-optic”) symbology reader 106, an additional camera 107 (e.g., a video camera) and associated illumination assembly 109 at least partially positioned within a housing of the barcode reader 106. In examples herein, the symbology reader 106 is referred to as a barcode reader. Further, in examples herein, the camera 107 may be referred to as an imaging assembly and may be implemented as a color camera or other camera configured to obtain images of an object illuminated by the illumination assembly 109.

Imaging systems herein may include any number of imagers housed in any number of different devices. While FIG. 1 illustrates an example bi-optic barcode reader 106 as the imager, in other examples, the imager may be a handheld device, such as a handheld barcode reader, or a fixed imager, such as barcode reader held in place in a base and operated within what is termed a “presentation mode.”

In the illustrated example, the barcode reader 106 includes a lower housing 112 and a raised housing 114. The lower housing 112 may be referred to as a first housing portion and the raised housing 114 may be referred to as a tower or a second housing portion. The lower housing 112 includes a top portion 116 with a first optically transmissive window 118 positioned therein along a generally horizontal plane relative to the overall configuration and placement of the barcode reader 106. In some examples, the top portion 116 may include a removable or a non-removable platter (e.g., a weighing platter including an electronic scale).

In the illustrated example of FIG. 1, the barcode reader 106 captures images of an object, in particular a product or item 122, such as, e.g., a package or a produce item, as it passes through a product scanning region (i.e., generally over the top portion 116 of the lower housing 112). In some implementations, the barcode reader 106 captures these images of the item 122 through one of the first and second optically transmissive windows 118, 120. For example, image capture may be done by positioning the item 122 within the fields of view (FOV) of the digital imaging sensor(s) housed inside the barcode reader 106. The barcode reader 106 captures images through these windows 118, 120 such that a barcode 124 associated with the item 122 is digitally read through at least one of the first and second optically transmissive windows 118, 120. In the illustrated example of FIG. 1, the camera 107 also captures images of the item 122, and generates image data that can be processed, e.g., using image recognition techniques, to identify the item 122, and/or individuals associated with the product (not shown in FIG. 1).

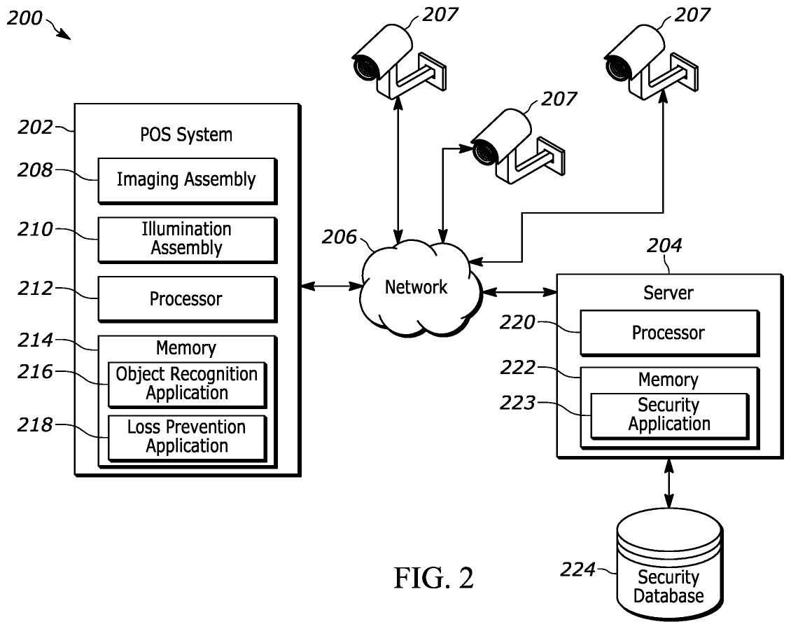

FIG. 2 illustrates a block diagram of an example system 200 including a logic circuit for implementing example methods and/or operations described herein, including methods and/or operations for identifying a person at a POS. The system 200 may include a POS system 202 (e.g., the imaging system 100) and a server 204 configured to communicate with one another via a network 206, which may be a wired or wireless network. In some examples, the system 200 may further includes one or more security cameras 207 positioned in a retail store environment associated with the POS system 202, which may also be configured to communicate with the POS system 202 and/or the server 204 via the network 206.

The POS system 202 may include an imaging assembly 208 (e.g., the imaging assembly 107), and an illumination assembly 210 (e.g., the illumination assembly 109). The illumination assembly 210 may be configured to illuminate a product scanning region associated with the POS system 202 as items pass through the product scanning region, and the imaging assembly 208 may be configured to capture a series of image frames (e.g., a burst of image frames) for each item as it passes through the product scanning region. In particular, the illumination assembly 210 may illuminate the product scanning region using a first illumination setting, e.g., configured for a brighter background and darker foreground in the image frames, as the imaging assembly 208 captures a first set of one or more image frames of the series of image frames for each item. As the imaging assembly 208 captures a second set of one or more image frames of the series of image frames, the illumination assembly 210 may illuminate the product scanning region using a second illumination setting, e.g., configured for a darker background and brighter foreground in the image frames compared to the first illumination setting.

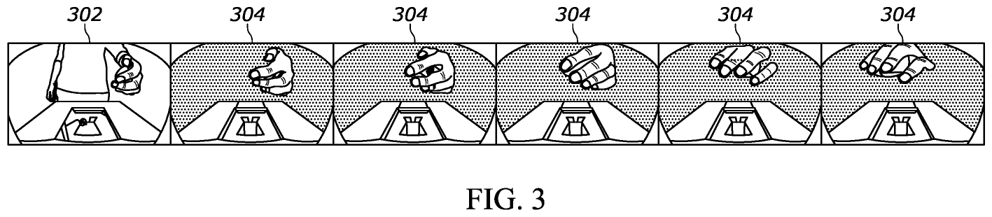

FIG. 3 illustrates an example series of image frames of a product scanning region, as may be captured using the imaging assembly 208. As shown in FIG. 3, a first set of image frames 302 of the series of image frames is captured as the illumination assembly 210 illuminates the product scanning region using a first illumination setting, or a first set of illumination settings, configured for a darker foreground and a brighter background. Furthermore, as shown in FIG. 3, a second set of image frames 304 of the series of image frames is captured as the illumination assembly 210 illuminates the product scanning region using a second illumination setting, or a second set of illumination settings, configured for a brighter foreground and a darker background, compared to the first illumination setting or first set of illumination settings.

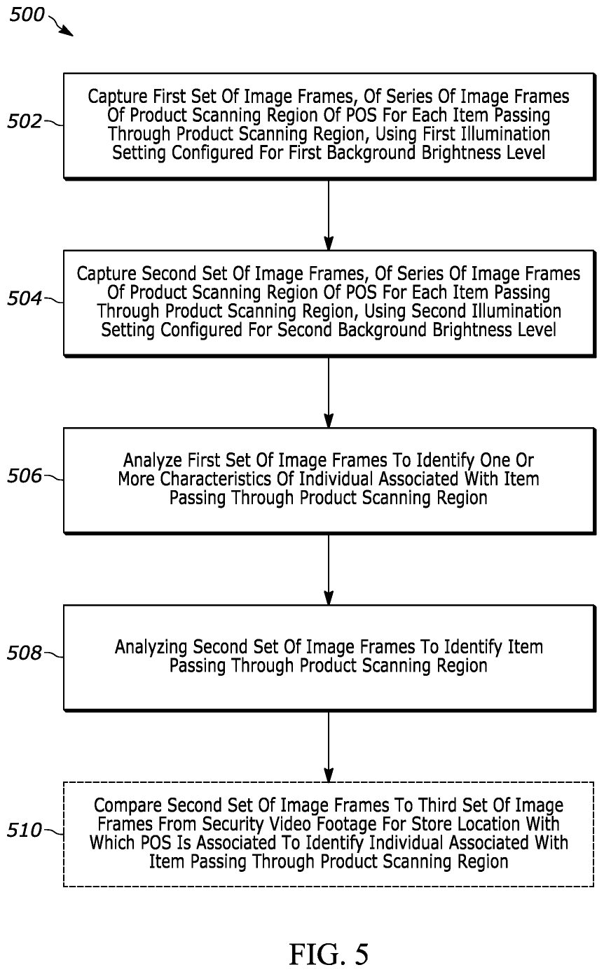

Referring back to FIG. 2, the POS system 202 may further include a processor 212 and a memory 214. The processor 212, which may be, for example, one or more microprocessors, controllers, and/or any suitable type of processors, may interact with the memory 214 accessible by the one or more processors 212 (e.g., via a memory controller) to obtain, for example, machine-readable instructions stored in the memory 214 corresponding to, for example, the operations represented by the method 500 shown at FIG. 5. In particular, the machine-readable instructions stored in the memory 214 may include instructions for executing an object recognition application 216 and/or instructions for executing a loss prevention application 218.

Executing the object recognition application 216 may include analyzing the second set of image frames 304 in order to identify an item 122 passing through the product scanning region, i.e., using object recognition techniques. For instance, executing the object recognition application 216 may include analyzing the images of the second set of image frames 304 in order to identify a particular type of produce, such as a banana or an apple, or to identify other types of products as they pass through the product scanning region, e.g., as the item 122 is purchased.

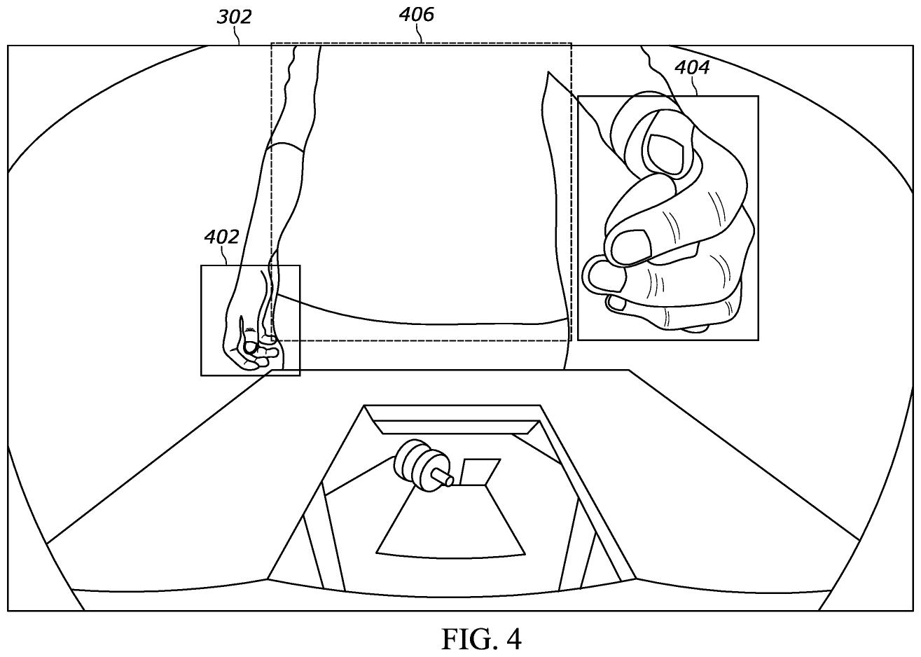

Executing the loss prevention application 218 may include analyzing the first set of image frames 302 in order to identify characteristics of an individual associated with the item 122 passing through the product scanning region. For instance, as shown in FIG. 4, an image frame 302 of the first set of image frames may be analyzed to identify a right hand 402, left hand 404, and torso 406 of an individual associated with the item 122 passing through the product scanning region. Analyzing the image frame 302 may include analyzing the image frame 302 in order to identify characteristics associated with the individual, such as, e.g., one or more articles of clothing being worn by the individual, one or more colors of articles of clothing being worn by the individual, an approximate height of the individual, an approximate weight of the individual, one or more facial features of the individual, etc. In some examples, executing the loss prevention application 218 may include sending image frames 302 of the first set of image frames, and/or characteristics identified based on the image frames 302, to the server 204.

Referring back to FIG. 2, the server 204 may include a processor 220 and a memory 222. The processor 220, which may be, for example, one or more microprocessors, controllers, and/or any suitable type of processors, may interact with the memory 222 accessible by the one or more processors 220 (e.g., via a memory controller) to obtain, for example, machine-readable instructions stored in the memory 222 corresponding to, for example, the operations represented by the method 500 shown at FIG. 5. In particular, the machine-readable instructions stored in the memory 222 may include instructions for executing a security application 223. In some examples, executing the security application 223 may include receiving image frames 302 of the first set of image frames, and/or characteristics associated with an individual depicted in the image frames 302 identified based on the image frames 302, from the POS system 202. For example, the security application 223 may store the image frames 302, and/or the characteristics of the individual identified based on the image frames 302 in a security database 224, or may compare the image frames 302, and/or the characteristics of the individual identified based on the image frames 302 to images or characteristics of individuals previously stored in the security database 224, i.e., to identify the individual. Additionally, in some examples, executing the security application 223 may include receiving image frames captured by one or more security cameras 207 positioned in a retail store associated with the POS system 202, and comparing the image frames captured by the security camera(s) 207 to the first set of image frames 302 captured by the imaging assembly 208 of the POS system, e.g., in order to identify the individual depicted in the first set of image frames 302, or to monitor the individual depicted in the first set of image frames 302 as he or she moves through the retail store environment.

In some examples, the memory 214 may include instructions for executing the security application 223 described above as being performed by the server 204. Moreover, in some examples, the memory 222 may include instructions for executing the object recognition application 216 and/or loss prevention application 218 described above as being performed by the POS system 202.

FIG. 5 illustrates a block diagram of an example process 500 as may be implemented by the system of FIG. 2, for implementing example methods and/or operations described herein, including methods and/or operations for identifying a person at a POS. One or more steps of the method 500 may be implemented as a set of instructions stored on a computer-readable memory (e.g., memory 214 and/or 222) and executable on one or more processors (e.g., processors 212 and/or 220).

At block 502, a series of image frames of a product scanning region associated with a POS system, may be captured, e.g., by an imaging assembly, such as imaging assembly 107 and/or 208, for each item passing through the product scanning region. A first set of image frames, of the series of image frames, may include one or more image frames, and may be captured using a first illumination setting (e.g., of an illumination assembly, such as illumination assembly 109 and/or 210) configured for a first background brightness level in the image frames.

At block 504, a second set of image frames, of the series of image frames of a product scanning region associated with a POS system, may be captured, e.g., by the imaging assembly, for each item passing through the product scanning region. The second set of image frames may include one or more image frames, and may be captured using a second illumination setting (e.g., of an illumination assembly, such as illumination assembly 109 and/or 210) configured for a second background brightness level in the image frames.

The second background brightness level may be different from the first background brightness level. In particular, the first background brightness level, in the first set of image frames, may be brighter than the second background brightness level, in the second set of image frames. For instance, in the first set of image frames, the foreground of the product scanning region, where the item passing through the product scanning region may be located, may be more darkened in the image frames, while the background of the product scanning region, where an individual associated with an item passing through the product scanning region may be located, may be more illuminated in the image frames. In contrast, in the second set of image frames, the foreground of the product scanning region, where the item passing through the product scanning region may be located, may be more illuminated in the image frames, while the background of the product scanning region, where an individual associated with an item passing through the product scanning region may be located, may be more darkened in the image frames.

At block 506, the first set of image frames may be analyzed, e.g., by one or more processors, such as processors 212 and/or 220, in order to identify one or more characteristics of an individual depicted in the image frames associated with the item passing through the product scanning region. For instance, the first set of image frames may be analyzed to identify one or more articles of clothing being worn by the individual, one or more colors of articles of clothing being worn by the individual, an approximate height of the individual, an approximate weight of the individual, one or more facial features of the individual, etc. In some examples, the first set of image frames, and/or any characteristics of the individual identified based on the analysis of the first set of image frames, may be stored in a security database.

At block 508, the second set of image frames may be analyzed, e.g., by one or more processors, such as processors 212 and/or 220, in order to identify the item passing through the product scanning region. For instance, in some examples, the second set of image frames may be analyzed using object recognition techniques to identify the item, or the general type of item, passing through the product scanning region depicted in the second set of image frames.

At block 510, optionally, the first set of image frames may be compared to a third set of image frames captured by one or more security cameras (e.g., security cameras 207) positioned in a retail store location associated with the POS system in order to identify the individual associated with the item passing through the product scanning region shown in the third set of image frames, e.g., to monitor the individual associated with the item that passed through the product scanning region as the individual moves throughout the retail store location.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for human characteristic and object characteristic identification at a point of sale (POS), comprising:
capturing, by an imaging assembly associated with a barcode reader configured for use at a POS workstation, a series of image frames of a product scanning region associated with the POS workstation for each item passing through the product scanning region,
wherein a first set of one or more image frames of the series of image frames for each item is captured using a first illumination setting configured for a first background brightness level in the image frames,
wherein a second set of one or more image frames of the series of image frames for each item is captured using a second illumination setting, wherein the second illumination setting is configured for a second background brightness level, different from the first background brightness level, in the image frames;
analyzing the first set of one or more image frames to identify one or more characteristics of an individual associated with the item passing through the product scanning region; and
analyzing the second set of one or more image frames to identify the item passing through the product scanning region.

2. The method of claim 1, wherein the first background brightness level is brighter than the second background brightness level.

3. The method of claim 1, wherein analyzing the second set of one or more image frames to identify the item includes using object recognition techniques to identify the item passing through the product scanning region based on the second set of one or more image frames.

4. The method of claim 1, wherein analyzing the first set of one or more image frames to identify one or more characteristics associated with the individual associated with the item passing through the product scanning region includes identifying, based on the first set of one or more image frames, one or more of: one or more articles of clothing being worn by the individual, one or more colors of articles of clothing being worn by the individual, an approximate height of the individual, an approximate weight of the individual, or one or more facial features of the individual.

5. The method of claim 1, further comprising: storing the first set of one or more image frames in a security database.

6. The method of claim 1, further comprising:
comparing the first set of one or more image frames to a third set of one or more image frames from security video footage for a store location with which the POS workstation is associated; and
identifying, based on the comparison, an individual associated with the item passing through the product scanning region shown in the third set of one or more image frames.

7. A system for human characteristic and object characteristic identification at a point of sale (POS), comprising:
an imaging assembly, associated with a barcode reader configured for use at a POS workstation, configured to capture a series of image frames of a product scanning region associated with the POS workstation for each item passing through the product scanning region;
an illumination assembly, associated with the barcode reader configured for use at the POS workstation, configured to:
for a first set of one or more image frames of the series of image frames, illuminate the product scanning region using a first illumination setting configured for a first background brightness level in the image frames;
for a second set of one or more image frames of the series of image frames, illuminate the product scanning region using a second illumination setting configured for a second background brightness level in the image frames, wherein the second background brightness level is different from the first background brightness level;
one or more processors, and
a memory storing non-transitory computer-readable instructions that, when executed by the one or more processors, cause the one or more processors to analyze the first set of one or more image frames to identify one or more characteristics of an individual associated with the item passing through the product scanning region and analyze the second set of one or more image frames to identify the item passing through the product scanning region.

8. The system of claim 7, wherein the first background brightness level is brighter than the second background brightness level.

9. The system of claim 7, wherein the instructions, when executed by the one or more processors, cause the one or more processors to analyze the second set of one or more image frames to identify the item by using object recognition techniques to identify the item passing through the product scanning region based on the second set of one or more image frames.

10. The system of claim 7, wherein the instructions, when executed by the one or more processors, cause the one or more processors to analyze the first set of one or more image frames to identify one or more characteristics associated with the individual by identifying, based on the first set of one or more image frames, one or more of: one or more articles of clothing being worn by the individual, one or more colors of articles of clothing being worn by the individual, an approximate height of the individual, an approximate weight of the individual, or one or more facial features of the individual.

11. The system of claim 7, wherein the instructions, when executed by the one or more processors, further cause the one or more processors to store the first set of one or more image frames in a security database.

12. The system of claim 7, wherein the instructions, when executed by the one or more processors, further cause the one or more processors to:
compare the first set of one or more image frames to a third set of one or more image frames from security video footage for a store location with which the POS workstation is associated; and
identify, based on the comparison, an individual associated with the item passing through the product scanning region shown in the third set of one or more image frames.

13. A barcode reader device configured for use at a point of sale (POS) workstation, for human characteristic and object characteristic identification, comprising:
an imaging assembly configured to capture a series of image frames of a product scanning region associated with the POS workstation for each item passing through the product scanning region;
an illumination assembly configured to:
for a first set of one or more image frames of the series of image frames, illuminate the product scanning region using a first illumination setting configured for a first background brightness level in the image frames;
for a second set of one or more image frames of the series of image frames, illuminate the product scanning region using a second illumination setting configured for a second background brightness level in the image frames, wherein the second background brightness level is different from the first background brightness level; and
a controller configured to communicate with a memory storing non-transitory computer-readable instructions that, when executed by one or more processors, cause the one or more processors to analyze the first set of one or more image frames to identify one or more characteristics of an individual associated with the item passing through the product scanning region and analyze the second set of one or more image frames to identify the item passing through the product scanning region.

14. The barcode reader device of claim 13, wherein the memory is located in one or more of the barcode reader device or a remote server.

15. The barcode reader device of claim 13, wherein the first background brightness level is brighter than the second background brightness level.

16. The barcode reader device of claim 13, wherein the instructions, when executed by the one or more processors, cause the one or more processors to analyze the second set of one or more image frames to identify the item by using object recognition techniques to identify the item passing through the product scanning region based on the second set of one or more image frames.

17. The barcode reader device of claim 13, wherein the instructions, when executed by the one or more processors, cause the one or more processors to analyze the first set of one or more image frames to identify one or more characteristics associated with the individual by identifying, based on the first set of one or more image frames, one or more of: one or more articles of clothing being worn by the individual, one or more colors of articles of clothing being worn by the individual, an approximate height of the individual, an approximate weight of the individual, or one or more facial features of the individual.

18. The barcode reader device of claim 13, wherein the instructions, when executed by the one or more processors, further cause the one or more processors to store the first set of one or more image frames in a security database.

19. The barcode reader device of claim 13, wherein the instructions, when executed by the one or more processors, further cause the one or more processors to:
compare the first set of one or more image frames to a third set of one or more image frames from security video footage for a store location with which the POS workstation is associated; and
identify, based on the comparison, an individual associated with the item passing through the product scanning region shown in the third set of one or more image frames.
